(19) United States
(12) Patent Application Publication
(10) Pub. No.: US 2016/0285219 A1
(43) Pub. Date: Sep. 29, 2016

(54) Modular Extension Cord Device

(71) Applicants: Jennifer D. Leverton, Georgetown, TX (US); Bryan Holmes, Georgetown, TX (US)

(72) Inventors: Jennifer D. Leverton, Georgetown, TX (US); Bryan Holmes, Georgetown, TX (US)

(21) Appl. No.: 14/670,515

(22) Filed: Mar. 27, 2015

(51) Int. Cl. H01R 27/02; H01R 13/713

(52) U.S. Cl. CPC H01R 27/02; H01R 13/7135

(57) ABSTRACT

A modular extension cord device allows for customizing outlets by using interchangeable components. The device includes a plug coupled to a first end of an initial component. An initial male electrical connector is coupled to a second end of the initial component and electrically coupled to the plug. Each of a plurality of medial components has a respective male electrical connector electrically coupled to a respective female electrical connector. Each female electrical connector is electrically couplable to one of the initial male electrical connector and the male electrical connector of a selectable one of the medial components. At least one associated auxiliary socket coupled to each medial component and is electrically coupled to the associated female electrical connector. A terminal component has a terminal female electrical connector couplable to a selectable one of the initial male electrical connector and each male electrical connector of the medial components.

### BACKGROUND OF THE DISCLOSURE

### Field of the Disclosure

The disclosure relates to extension cord devices and more particularly pertains to a new extension cord device for customizing the number and type of outlets provided using interchangeable components to provide a desired function or appearance.

### SUMMARY OF THE DISCLOSURE

An embodiment of the disclosure meets the needs presented above by generally comprising a plug coupled to a first end of an initial component. An initial male electrical connector is coupled to a second end of the initial component and electrically coupled to the plug. Each of a plurality of medial components has a respective male electrical connector electrically coupled to a respective female electrical connector. Each female electrical connector is electrically couplable to one of the initial male electrical connector and the male electrical connector of a selectable one of the medial components. At least one associated auxiliary socket coupled to each medial component and is electrically coupled to the associated female electrical connector. A terminal component has a terminal female electrical connector couplable to a selectable one of the initial male electrical connector and each male electrical connector of the medial components.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a modular extension cord device according to an embodiment of the disclosure.

FIG. 2 is a top view of an embodiment of the disclosure in an assembled position.

FIG. 3 is a top view of an embodiment of the disclosure in a partially exploded position.

FIG. 4 is a top front side perspective view of a component of an embodiment of the disclosure.

FIG. 5 is a top view of a component of an embodiment of the disclosure.

### DESCRIPTION OF THE PREFERRED EMBODIMENT

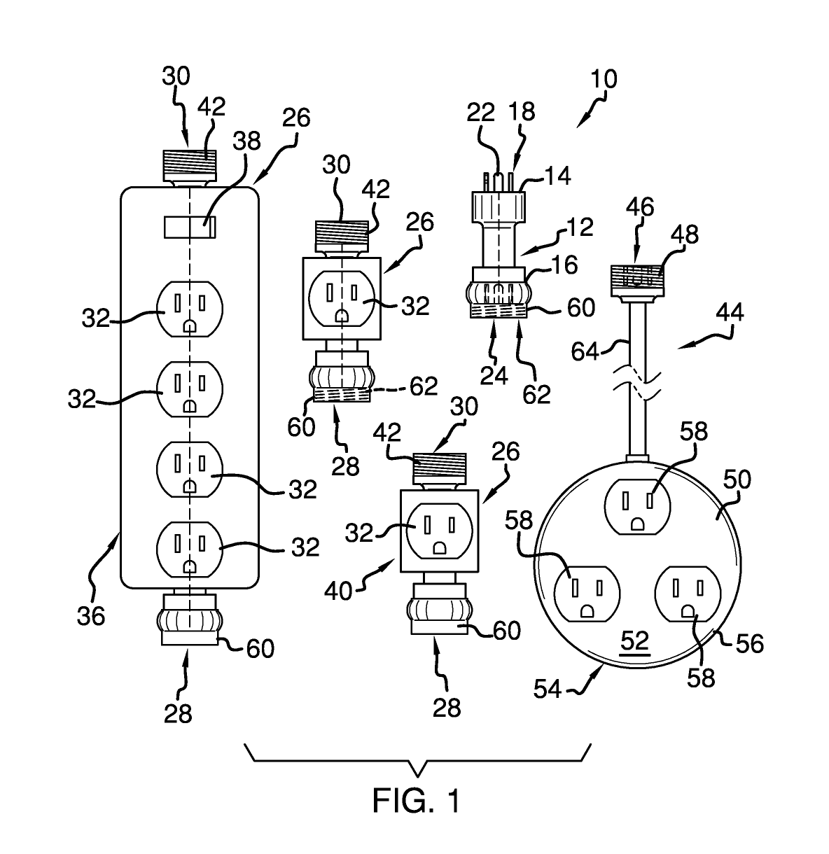

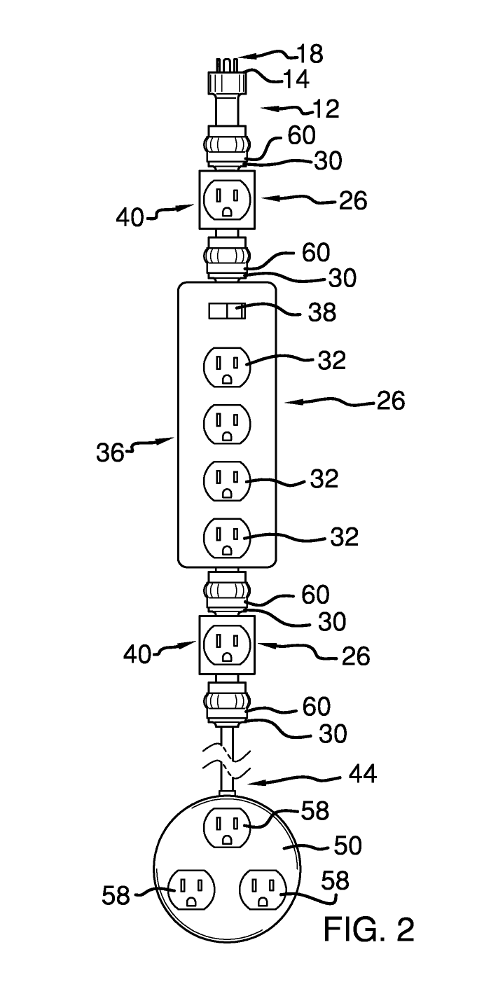

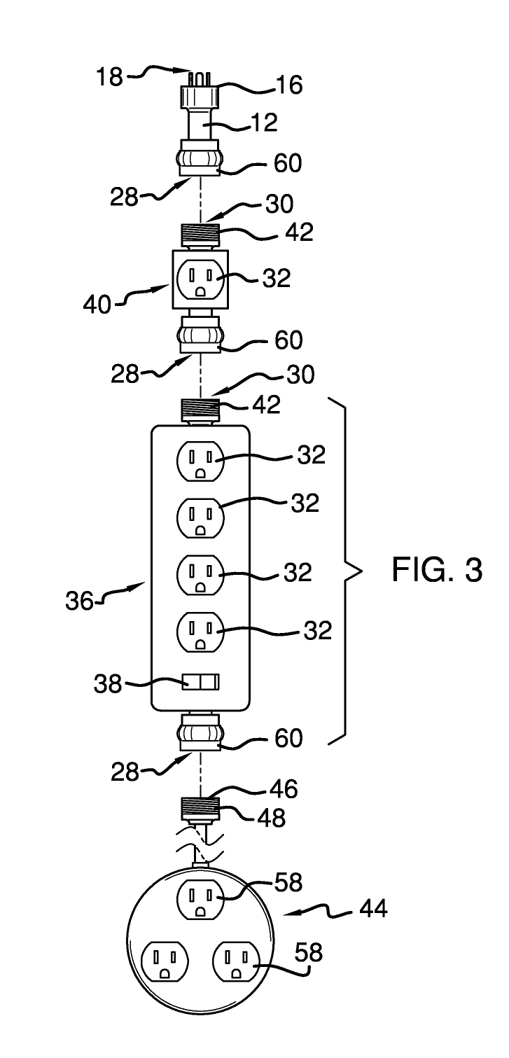

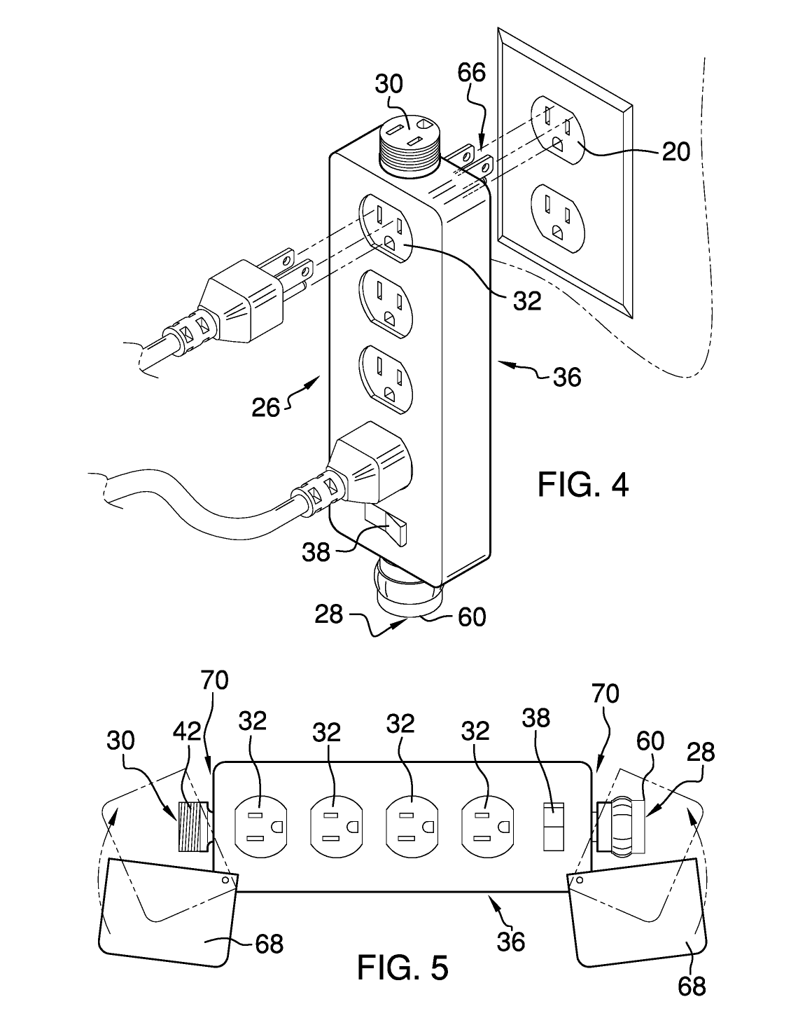

With reference now to the drawings, and in particular to FIGS. 1 through 5 thereof, a new extension cord device embodying the principles and concepts of an embodiment of the disclosure and generally designated by the reference numeral 10 will be described.

As best illustrated in FIGS. 1 through 5, the modular extension cord device 10 generally comprises an initial component 12 having a first end 14 and a second end 16. A plug 18 is coupled to the first end 14 of the initial component 12. The plug 18 is configured for electrically coupling to a conventional electrical outlet 20 and includes a ground prong 22. An initial male electrical connector 24 is coupled to the second end 16 of the initial component 12. The initial male electrical connector 24 is electrically coupled to the plug 18. Each of a plurality of medial components 26 has a respective male electrical connector 28 and a respective female electrical connector 30. Each respective female electrical connector 30 is electrically coupled to the respective male electrical connector 28 allowing electrical current to pass through the intermediate component 26. This also allows several medial components 26 to be used in combination. Each female electrical connector 30 is electrically couplable to the initial male electrical connector 24 or the male electrical connector 28 of a selectable one of the medial components 26. At least one associated auxiliary socket 32 is coupled to each medial component 26. Each female electrical connector 30 is electrically coupled to each associated auxiliary socket 32 providing electrical current when an electrical apparatus is electrically coupled to the auxiliary socket 32.

The medial components 26 may comprise different configurations to permit customization of the provision of electrical current in a desired form. The medial components 26 may include one or more surge protector components 36. The surge protector component 36 suppresses voltage beyond a threshold voltage from passing to each auxiliary socket 32 coupled to the surge protector component 36 in a conventional manner. The surge suppressor component 36 includes a switch 38 coupled to the surge compressor component 36. The switch 38 is electrically coupled between the female electrical connector 30 and each auxiliary outlet 32 coupled to the surge suppressor component 36. The medial components 26 may also include one or more extension components 40. Each extension component 40 includes a single auxiliary socket 32 coupled to the extension component 40. Thus, each extension component 40 may be used to facilitate providing one additional source of electrical current. Each female electrical connector 30 has a threaded peripheral wall 42. The surge protector component 36 may include a rear plug 66 allowing it to be plugged directly into the conventional electrical outlet 20. The rear plug 66 may be provided at a middle of the rear side of the surge protector component 36. The rear plug 66 may also be positioned in an inset 96 into the surge protector component 36 to allow the rear plug 66 to be covered when not in use. When inset, the rear plug 66 may be accessed using a conventional extension fitting within the inset 96 or the rear plug 66 may be extendable from the inset 96 in a conventional manner. As shown in FIG. 5, pivotable end caps 68 may be coupled to respective ends 70 of the surge protector component 36 covering the female electrical connector 30 and male electrical connector 28 respectively when not in use.

A terminal component 44 is provided having a terminal female electrical connector 46 couplable to a selectable one of either the initial male electrical connector 24 in the case of a minimal number of access points being desired, or each male electrical connector 28 of the medial components 26 allowing multiple configurations. The terminal female electrical connector 46 has a threaded perimeter surface 48 structurally similar to each threaded peripheral wall 42. The terminal component 44 includes a terminal housing 50 having an upper face 52, a lower face 54, and an annular perimeter wall 56 such that the terminal component 44 is substantially disc-shaped. The terminal component 44 may have a plurality of terminal electrical sockets 58 positioned on the upper face 52. An electrical cord 64 is electrically coupled to and extends between the terminal female electrical connector 46 and the terminal housing 50 allowing for positioning of the terminal housing 50 in spaced relationship to the nearest medial component 26. The electrical cord 64 may be provided in any desired length. Varied lengths may be provided to allow for customization of the distance between the terminal housing 46 and the nearest connected medial component 26.

Each of a plurality of rotatable collars 60 is positioned around an associated one of the male electrical connectors 28 and the initial male electrical connector 24. Each rotatable collar 60 has inwardly facing threading 62 complementary to the threaded peripheral wall 42 of each female electrical connector 30 and the threaded perimeter surface 48 of the terminal female electrical connector 46. Thus, the initial component 12, selected medial components 26, and the terminal component 44 are secured together in a manner allowing interchanging of positions of the medial components 26 while inhibiting unintended disengagement within the device 10.

In use, the device 10 is customized by serially coupling desired medial components 26 between the initial component 12 and the terminal component 44. Thus, access to auxiliary electrical sockets 32 may be configured and customized as desired for a particular location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A modular extension cord device comprising:
an initial component having a first end and a second end;
a plug being coupled to said first end of said initial component, said plug being configured for electrically coupling to an electrical outlet;
an initial male electrical connector being coupled to said second end of said initial component, said initial male electrical connector being electrically coupled to said plug;
a plurality of medial components, each of said medial components having a respective male electrical connector and a respective female electrical connector, each respective female electrical connector being electrically coupled to said respective male electrical connector, each said female electrical connector being electrically couplable to one of said initial male electrical connector and said male electrical connector of a selectable one of said medial components, each said medial component having at least one associated auxiliary socket, each female electrical connector being electrically coupled to each said associated auxiliary socket;
said medial components comprising a surge protector component, said surge protector component suppressing voltage beyond a threshold voltage from passing to each said auxiliary socket coupled to said surge protector component;
a pair of pivotable end caps coupled to respective ends of said surge protector component;
a terminal component, said terminal component having a terminal female electrical connector couplable to a selectable one of said initial male electrical connector and each said male electrical connector of said medial components;
said terminal female electrical connector having a threaded perimeter surface;
each female electrical connector having a threaded peripheral wall;
a plurality of rotatable collars, each rotatable collar being positioned around an associated one of said male electrical connectors and said initial male electrical connector, each said rotatable collar having inwardly facing threading complementary to said threaded peripheral wall of each said female electrical connector and said threaded perimeter surface of said terminal female electrical connector.

2. The device of claim 1, further comprising said terminal component comprising a terminal housing, said terminal housing having an upper face, a lower face, and an annular perimeter wall.

3. The device of claim 2, further comprising said terminal component having a plurality of terminal electrical sockets positioned on said upper face.

4. The device of claim 1, further comprising said medial components comprising a surge protector component, said surge protector component suppressing voltage beyond a threshold voltage from passing to each said auxiliary socket coupled to said surge protector component.

5. The device of claim 4, further comprising said surge suppressor component comprising a switch coupled to said surge compressor component, said switch being electrically coupled between said plug end and each said auxiliary outlet coupled to said surge suppressor component.

6. The device of claim 1, further comprising said medial components comprising an extension component, each said medial component comprising a single auxiliary socket coupled to said extension component.

7. (canceled)

8. The device of claim 3, further comprising an electrical cord electrically coupled to and extending between said terminal female electrical connector and said terminal housing.

9. A modular extension cord device comprising:
an initial component having a first end and a second end;
a plug being coupled to said first end of said initial component, said plug being configured for electrically coupling to an electrical outlet;
an initial male electrical connector being coupled to said second end of said initial component, said initial male electrical connector being electrically coupled to said plug;
a plurality of medial components, each of said medial components having a respective male electrical connector and a respective female electrical connector, each respective female electrical connector being electrically coupled to said respective male electrical connector, each said female electrical connector being electrically couplable to one of said initial male electrical connector and said male electrical connector of a selectable one of said medial components, each said medial component having at least one associated auxiliary socket, each female electrical connector being electrically coupled to each said associated auxiliary socket, said medial components comprising a surge protector component, said surge protector component suppressing voltage beyond a threshold voltage from passing to each said auxiliary socket coupled to said surge protector component, said surge suppressor component comprising a switch coupled to said surge compressor component, said switch being electrically coupled between said plug end and each said auxiliary outlet coupled to said surge suppressor component, said medial components comprising an extension component, each said medial component comprising a single auxiliary socket coupled to said extension component, each female electrical connector having a threaded peripheral wall;
a pair of pivotable end caps coupled to respective ends of said surge protector component;
a terminal component, said terminal component having a terminal female electrical connector couplable to a selectable one of said initial male electrical connector and each said male electrical connector of said medial components, said terminal female electrical connector having a threaded perimeter surface, said terminal component comprising a terminal housing, said terminal housing having an upper face, a lower face, and an annular perimeter wall, said terminal component having a plurality of terminal electrical sockets positioned on said upper face;
a plurality of rotatable collars, each rotatable collar being positioned around an associated one of said male electrical connectors and said initial male electrical connector, each said rotatable collar having inwardly facing threading complementary to said threaded peripheral wall of each said female electrical connector and said threaded perimeter surface of said terminal female electrical connector; and
an electrical cord electrically coupled to and extending between said terminal female electrical connector and said terminal housing.
